(19) United States
(12) Patent Application Publication
(10) Pub. No.: US 2023/0016969 A1
(43) Pub. Date: Jan. 19, 2023

(54) ROPE HAULING AND DEPLOYMENT CONTAINER AND SYSTEM FOR RAPPELLING

(71) Applicant: SLOT LLC, Evergreen, CO (US)

(72) Inventor: David Schipper, Moab, UT (US)

(21) Appl. No.: 17/859,152

(22) Filed: Jul. 7, 2022

Related U.S. Application Data
(60) Provisional application No. 63/219,235, filed on Jul. 7, 2021.

(51) Int. Cl. A62B 1/18; A45F 3/04; A63B 29/02

(52) U.S. Cl. CPC A62B 1/18; A45F 3/04; A63B 29/02; A45F 2003/003

(57) ABSTRACT

The present disclosure relates to an article and related system for hauling and deploying rope, including a main body having an upper portion defining a rim portion forming at least a portion of a primary opening into an interior chamber of the main body, a divider wall separating the interior chamber into at least two separate compartments inside the main body, a lid extending from the upper rim of the main body, the lid movable between a first orientation allowing access to the primary opening and a second orientation at least partially covering the primary opening, the lid having a peripheral edge forming a continuous extension of the rim portion that defines the portion of the primary opening, the lid including a loop structure at a central location on a free edge of the lid and an elongated seam binding attached to and covering the entirety of the peripheral edge and the rim portion, the seam binding forming a load bearing structural loop and a guide surface along the length of the rim portion and peripheral edge of the lid for smoothly engaging a length of rope deployed from the container.

### CROSS-REFERENCE TO RELATED APPLICATIONS

This application claims the benefit of priority pursuant to 35 U.S.C. § 119(e) of U.S. provisional patent application No. 63/219,235, filed Jul. 7, 2021, entitled “Rope Hauling and Deployment Container and System for Rappelling,” which is hereby incorporated by reference herein in its entirety.

### BACKGROUND

Rappelling allows a person (rappeller) to move from a higher relative position to a lower relative position by descending on a rope or other like means. Often times rappelling occurs along a steep face of a canyon, a rock wall, a building or other structure, or in some instances may be through space with no adjacent structure.

Canyoneering relates to the exploration of canyon structures for educational, cultural, scientific and recreational purposes. Rappelling down a canyon wall to enter into a canyon, and climbing up the same or different canyon wall to exit the canyon are fundamental requirements of canyoneering. Sometimes canyoneering requires several rappelling and climbing stages in order to access the intended part of a canyon. Efficient rope management is mandatory for personal safety, equipment care, and to minimize environmental impact.

There are many accepted forms of rappelling, with the single rope rappelling technique being widely considered as the superior manner for accessing technical slot canyons. Single rope rappelling is desirable for many reasons, including that a retrieval line is available for emergency uses, a free end of the rappelling rope can be set to a desired position above the end of the rappel stage with the advantages of minimizing twists in the rope and keeping the end of the rope clean, the wear points on the rope may be spread out along the length of a rope, a contingency anchor may easily be rigged with a single line, and a single line may be ascended if necessary. Additionally, a contingency knot may be used at the anchor that allows the length of the rappelling rope side to be lengthened if required.

The technique of single rope rappelling may require a blocking technique to fix a single line for rappel. Blocking techniques may include knots to fix to a quick link or to fix a rope for two people to descent separate strands of the rope, or may include contingency anchors to allow a person at the top anchor to release a single rap line under load to transfer weight to another rope, to lower an incapacitated rappeller to the ground, or to adjust the length of a rope if more rope is needed to complete the rappel stage.

The benefits of the single rope rappelling technique are not fully achieved with the design features of current rope hauling containers or bags. Many rope hauling containers or bags are relatively unstructured duffle-bag type containers that provide convenient rope hauling purpose, but do not include additional features that are useful during the rappelling and ascent stages required during a canyoneering outing or other rappelling situation. For instance see the Mammut Crag, DMM Classic, Metolius Ropemaster HC, Petzl Kab, and other related products.

A rope hauling and deployment container includes a main body including an upper portion defining a rim portion forming at least a portion of a primary opening into an interior chamber of the main body; a divider wall separating the interior chamber into at least two separate compartments inside the main body; a lid extending from the rim portion. The lid is movable between a first orientation allowing access to the primary opening and a second orientation at least partially covering the primary opening, the lid has a peripheral edge forming a continuous extension of the rim portion that defines the portion of the primary opening, the lid includes a loop structure at a central location on a free edge of the lid; and an elongated seam binding attached to and covering at least a portion of the peripheral edge and the rim portion, the seam binding forming a load bearing structural loop and a guide surface along the at least a portion of the peripheral edge and the rim portion for smoothly engaging a length of rope deployed from the container.

Optionally in some embodiments, the divider wall is attached in at least two different locations within the interior chamber, and is flexible to allow items in each of the separate compartments to be stacked vertically with respect to one another.

Optionally in some embodiments, the main body includes shoulder straps attached to a back wall thereof.

Optionally in some embodiments, the main body further comprises a back wall; the divider wall includes two laterally-spaced edges; each of the at least two laterally spaced edges is attached at respective spaced apart locations along the back wall; the divider wall includes a bottom edge extending between the two laterally-spaced edges and attached to the back wall; and the divider wall and the back wall define one of the at least two separate compartments.

Optionally in some embodiments, a bottom portion of the divider wall includes at least one aperture formed therein.

Optionally in some embodiments, the one of the at least two separate compartments has a volume smaller than the other of the at least two separate compartments.

Optionally in some embodiments, at least two separate compartments are accessible through the primary opening.

Optionally in some embodiments, the main body further comprises a front wall and a back wall, and the divider wall has a top edge selectively movable from a position adjacent to the front wall to a position adjacent to the back wall.

Optionally in some embodiments, the main body further comprises a front wall and a back wall; the divider wall has a fastener positioned along a top edge thereof; and the fastener is selectively coupleable to either the front wall to enlarge the primary opening to a first of the at least two separate compartments, or the back wall to enlarge the primary opening to a second of the at least two separate compartments.

Optionally in some embodiments, a first of the at least two separate compartments is accessible through the primary opening, and a second of the at least two separate compartments is accessible through an exterior pocket formed in the main body.

Optionally in some embodiments, the divider wall is at least partially attached at opposing side portions of the back wall, and at least partially attached a lower portion of the back wall.

Optionally in some embodiments, a first compartment of the at least two separate compartments is funnel-shaped and a second compartment of the at least two separate compartments is wedge shaped.

Optionally in some embodiments, the lid is secured to the main body by a linear closure mechanism.

Optionally in some embodiments, the main body comprises a front wall and the lid extends from the front wall.

Optionally in some embodiments, the main body comprises a back wall and the lid extends from the back wall.

A rope hauling and deployment container includes: a main body including a front panel and a back panel that, together, at least partially define an interior chamber of the main body and a primary opening in communication with the interior chamber, a lid portion extending continuously from the front panel or the back panel, the lid portion and the rim portion together defining a peripheral edge, wherein the peripheral edge is covered at least in part by a seam binding; and a divider wall separating the interior chamber into at least two compartments inside the main body.

Optionally in some embodiments, the divider wall has a top edge selectively movable from a position adjacent to the front panel to a position adjacent to the back panel, and wherein the top edge is selectively securable in each position.

Optionally in some embodiments, the container includes a secondary opening formed in an exterior of the main body. A first of the at least two compartments is accessible through the primary opening, and a second of the at least two compartments is accessible through the opening.

Optionally in some embodiments, a first compartment of the at least two separate compartments is funnel-shaped and a second compartment of the at least two separate compartments is wedge shaped, the first and second compartments defining the volume of the interior chamber.

A rope hauling and deployment container includes: a main body that defines an interior chamber, wherein the interior chamber is accessible via a primary opening with a peripheral edge formed in an upper portion of the main body; a divider wall separating the interior chamber into at least two compartments inside the main body; and a seam binding attached to at least a portion of the peripheral edge, and forming a load bearing structural loop. The seam binding forms a guide surface along at least a portion of the peripheral edge configured to smoothly engage a length of rope deployed from the container.

It is with these shortcomings in mind that the inventions described and claimed in the disclosure below are directed.

### BRIEF DESCRIPTION OF THE SEVERAL VIEWS OF THE DRAWINGS

FIG. 1a is a side view of an example of a rope hauling container with a rope length received in a lower portion of an internal rope compartment formed in part by an example of a flexible divider wall.

FIG. 1b is a side view of the example of FIG. 1a, gear items received in an internal gear compartment and positioned generally vertically above the length of rope in the bottom portion of the rope compartment, with the divider wall separating the two compartments.

FIG. 1c is a side view of the example of FIG. 1c with a lid closed over the top opening of the rope hauling container and a portion of the rope extending between a rim of the top opening and the lid.

FIG. 1d is a side view of the example of FIG. 1c with another length of rope received in a top portion of the rope compartment and being positioned generally above the gear received in the gear compartment, which in turn is generally above the length of rope in the bottom portion of the rope compartment, and the divider wall separating the rope compartment from the gear compartment.

FIG. 2a is an example of the rope hauling container suspended on a wall surface, along with an anchor, and with a length of rope passing through a portion of the anchor.

FIG. 2b depicts a rappeller rappelling down a steep face on a length of rope secured to the anchor.

FIG. 2c depicts a rappeller rappelling down a steep face on a length of rope secured to the anchor, and while wearing the rope hauling container with additional rope playing out of the rope container as the rappeller descends the rope.

FIG. 3 depicts a canyoneer, once the rappel is completed, pulling the rope from the anchor and directing it into the rope compartment for storage, transport, and in preparation for further use.

FIG. 4a is a perspective view of the rope hauling container of FIGS. 1a-1d in greater detail, with the lid closed and a length of rope extending between the edge of the lid and the top rim of the main opening.

FIG. 4b is a partial perspective view of the top portion of the rope hauling container of FIG. 4a, with the lid in an open configuration and showing the folding axis of the lid as it moves from an open configuration to a closed configuration.

FIG. 4c is a section taken along the line 4c-4c of FIG. 4b, and shows an example of the attachment of the seam binding.

FIG. 5 is an enlarged partial perspective view of the end portion of the lid, showing details of the attachment loop and peripheral seam binding.

FIG. 6a is a top plan view of the rope hauling container shown in FIG. 4a with the lid open and showing an internal cavity with an example of the divider wall adjacent the back wall of the container.

FIG. 6b is a section taken along line 6b-6b of FIG. 6a showing the internal cavity with the divider wall adjacent the back wall of the container.

FIG. 7a is a top plan view of the rope hauling container shown in FIG. 4a with the lid open and showing an internal cavity with the divider wall positioned mid-way between the back wall of the container and the front wall of the container.

FIG. 7b is a section taken along line 7b-7b of FIG. 7a showing the internal cavity with the divider wall positioned mid-way between the back wall of the container and the front wall of the container.

FIG. 8a is a top plan view of the rope hauling container shown in FIG. 4a with the lid open and showing an internal cavity with the divider wall adjacent the front wall of the container.

FIG. 8b is a section taken along line 6b-6b of FIG. 6a showing the internal cavity with the divider wall adjacent the front wall of the container.

FIG. 9a is a partial exploded view of the divider wall from the back wall of the rope hauling container.

FIG. 9b is a section view similar to FIG. 7b, but showing another example of a divider wall, with the divider wall extending from the front wall of the rope hauling container.

FIG. 10a is a front view of another example of the rope hauling container, with the lid in an open position and an external compartment with an opening extending across a front panel of a front wall.

FIG. 10b is a front view of another example of the rope hauling container, with the lid in an open position and an external compartment formed in a gusseted section extending outwardly from a front panel of a front wall.

FIG. 11 is a side elevation view of the example of FIG. 10a, showing the opening extending along a side panel, and showing in dash the periphery of a divider panel separating the internal cavity into a rope hauling compartment and a gear hauling compartment.

FIG. 12 is a representative section of the example of FIG. 11, with a length of rope positioned in the rope compartment and a gear positioned in the gear compartment with the opening shown in open configuration.

FIG. 13 is side elevation view of another example of the rope hauling container with an external opening to the gear compartment, and with the lid extending from the front wall of the container, and showing a zippered closure mechanism for securing the periphery of the lid to the top rim defining the main opening.

FIG. 14 is a front perspective view of the example rope hauling container as shown in FIG. 13, and shows the folding axis of the lid as it moves from an open configuration to a closed configuration.

### SUMMARY

The rope hauling container and various features and methods as described and claimed herein may be useful and beneficial in the areas of canyoneering, rock climbing, rescue efforts, caving, and military and/or police tactical scenarios. Generally, the rope hauling container may allow the rappeller to deploy a desired length of rope for the height of the rappel. This is compared to the common scenario where more rope is deployed than is needed for a particular rappel, which results in a loud noise as the excess rope hits the ground or other structure, and also requires that more rope than was needed or desired be exposed to dirt, water, and other potential wear, as well as to be retrieved when completed. The rope hauling container may make the rappelling of one pitch routes and multi-pitch routes (in any one or more of the above mentioned scenarios) more efficient and safe. Additionally or separately, it may provide an advantage in situations where stealth and quiet are desired (such as in police or military rappelling scenarios) because the length of descending rope can be changed or altered depending on the height of the rappel, and no excess rope may land noisily on the ground or structure beneath the rappel. Additionally or separately the retrieval of post-rap rope is more efficient and unobtrusive since only the needed length of rope for the height of the rappel need be retrieved. The rope hauling container may also be beneficial for caving because length of the rope to be deployed may be varied as needed in dark scenarios or dropping into pools of water.

The rope hauling container is described herein with respect to its use in the canyoneering context, although it may be beneficial for use in many other rappelling opportunities as noted above. A rope hauling pack is provided with structural features beneficial to the canyoneering experience. The rope hauling container as described and claimed herein may, individually or in combination, assist with rope management to keep a rope clean, provide for ease of carrying rope during a rappel, facilitate safe stacking/flaking of a rope into the container, separate gear and equipment from the rope to reduce or eliminate interference of flaking/staking the rope or extracting the rope from the container, and/or work as a functional part of a rappel or ascent.

In particular the rope hauling container as described herein is designed to manage one's rope and canyoneering gear at the precipitous and often narrow or nonexistent stance at the top of a rappel. The rope hauling container is designed to be suspended by its open top flap. From its suspended position, the rope hauling container gives convenient access to rope, gear, movable accessory pouches and internal pockets. The gear connection points and the accessory connection points on the rope hauling container may each be load-bearing.

The interior cavity in the rope hauling container is functionally divided into at least two internal compartments, for example a first compartment such as a rope compartment and a second compartment, such as a gear compartment. The at least two compartments are defined in part by and separated by a flexible divider wall that is both selectively positionable within the container and is also flexible to adjust for the contents within each of the rope compartment and/or the gear compartment. A stacked rope will deploy easily from the rope compartment while gear and equipment is kept from interfering with the rope, as well as kept clean, dry and accessible when in the gear compartment.

### DETAILED DESCRIPTION

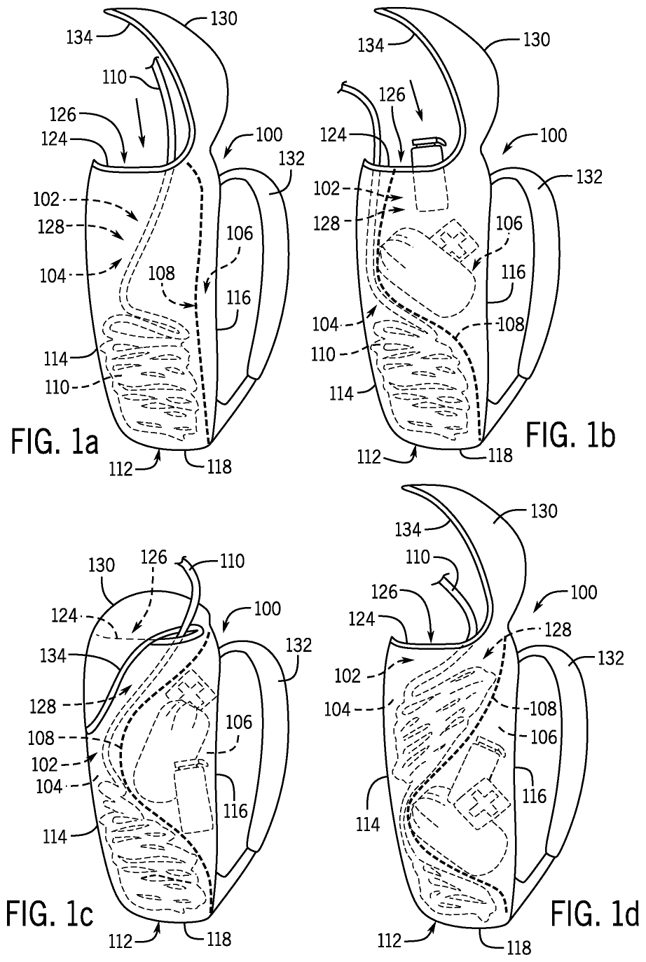

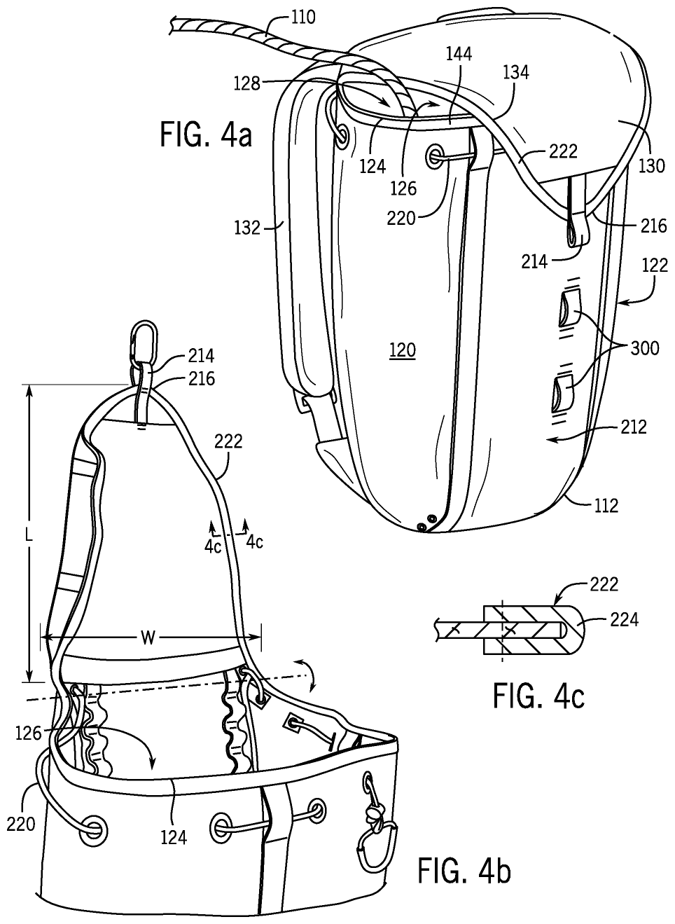

FIGS. 1a and 1b are schematic representations of one example of the rope hauling container, which may take the form of a backpack shown in in more detail in FIGS. 4a-9a. The present disclosure relates to a container 100 having an interior cavity or chamber 102 that includes at least two internal compartments 104, 106 separated by a divider wall 108 for isolating the items received in each of the separated internal compartments 104, 106. The divider wall 108 may be selectively positionable in order to facilitate the convenient placing of items in either of the at least two compartments. The divider wall 108 may be flexible to adapt to the shape of the items in either or both of the at least two compartments. A wall such as a divider wall, back wall, front wall or side walls may be referred to as panels herein.

The container 100 may define a main body 112 having a front side 114, a back side 116, a bottom side 118, and opposing lateral sides 120, 122 (see FIG. 4a) that space the front and back sides apart from one another. A rim 124 (also referred to as a rim portion 124) may define an opening 126 formed at or near the top of the main body, the rim 124 in one example being formed by top edges of the front, back, and opposing sides, respectively. The opening of the main body allows access to the main compartment 128 of the main body. The main compartment 128 of the main body 112 may be bounded by the back wall 116 (also referred to as a rear wall or panel), front wall 114, and side walls 120, 122 and/or interior surfaces of the same. A lid 130 (or lid portion 130) is attached to the main body, in this example at or adjacent a top portion of the back side 116. The lid 130 defines a lid body defining a peripheral edge extending around the lid body but for where the lid body is attached to or extends from the main body. The lid 130 may be moved between an open position (FIG. 1a) where the opening 126 is exposed for access into the main compartment 128, such as for top-loading the main body, and a closed position (FIG. 1c) where the lid 130 may cover all of the opening 126, or at least a portion of the opening 126, as described further below. At least one strap, such as in one example shoulder straps 132, may be secured to the main body 112. In some examples, the shoulder straps may be attached to the back panel of the main body, but the strap or shoulder straps may be secured at many alternative locations on the main body.

FIGS. 1a-1d show a simplified schematic view of the clarified structure of the backpack shown in FIGS. 4a-9 in order to focus on the at least two internal compartments 104, 106 and the divider wall 108. In this example, internal compartment 104 of main compartment 128 is adjacent the front side 114 and forms a front compartment. Likewise, the internal compartment 106 is generally adjacent the back wall 116 and forms a rear or back compartment 106. The front compartment 104 and the rear compartment 106 may each receive items that are separated from one another by the divider wall 108. The divider wall 108 may be secured to the inside walls of the main body 112 and extends at least in part laterally between the opposing sidewalls 120, 122 to separate the front and rear compartments. The divider wall 108 may be made of a flexible woven or non-woven material, or a combination, which may be of natural fabric or man-made material. The divider wall 108 may be made of material that is inextensible such as nylon, or stretchable, such as Lycra, or a combination of inextensible or stretchable materials.

In the example of FIGS. 1a-1d, the divider wall 108 may, in whole or in part, be positioned near the back wall 116 to enlarge the front compartment 104 and reduce the size of the rear compartment 106 (such as shown in FIG. 1a). The divider wall 108 may also be positioned, in whole or in part, near the front wall 114 to enlarge the rear compartment 106 and reduce the size of the front compartment 104. As shown in FIG. 1a, the divider wall 108 is positioned adjacent the back wall 116 when the front compartment 104 receives a length of rope 110 stored therein with a portion of the rope extending out of the main compartment 128. In this example, the rope is in the bottom portion of the front compartment 104, and may take up a some or all of the full depth dimension (as measured between the front wall 114 and back wall 116) of the main compartment and some or all of the full width dimension (as measured between the opposing side walls 120, 122) of the main compartment, and fills up about one third the height dimension (as measured between the bottom wall 118 and the top rim 124) of the main compartment 128. With nothing in the rear compartment 106, the front compartment 104 takes up more than 50%, and possibly all, of the main internal compartment 128 in FIG. 1a. As shown in FIG. 1b, when items, such as gear including a water bottle, storage sack and first aid kit, are positioned in the back compartment 106 the gear is placed at least partially vertically above or on top of the rope received in the front compartment 104. A portion of the divider wall 108 in a bottom portion of the main compartment is adjacent the back wall 116 of the main body, held there by the volume of the stored rope length. The divider wall 108 generally conforms to the shape of the stored rope length, so where the height of stored rope length terminates, the divider wall bends over the top of the stored rope length towards the front wall 114 to receive the gear into the back compartment 106. The gear is positioned in the main body and within the back compartment 106, but is stacked vertically on top and maintained separate from the items in the front compartment 104. A portion of the stored rope length extends out of the front compartment 104 through a top opening of the front compartment 104.

FIGS. 1c and 1d show the loading scenario where an additional length of rope is positioned in the front compartment 104 and vertically above (and at the top of the height of the main compartment 128) the gear stored in the back compartment 104 (and at a mid-height of the main compartment 128), which is in turn vertically above the length of rope stored in the bottom portion of the front compartment 104 and at the bottom of the main compartment 128. The divider wall 108 is shown having been moved from its position in FIG. 1b to conform to the additional items positioned in the front compartment 104. In FIGS. 1c and 1d, the divider wall 108 is shown in an irregular shape, such as a serpentine shape. In FIG. 1c, the lid 130 is show in a “closed” orientation whereby the lid 130 covers all or substantially all of the opening 126 formed in the main body 112. In some instances, such as shown in FIG. 4a, the lid 130 may only cover a part of the opening 126, with another portion of the opening 126 extending beyond the peripheral edge of the lid 130. There is room for the rope to extend between the rim 124 at the top of the main body 112 and the peripheral edge 132 of the lid whether the lid fully covers the opening 126, or only partially covers the opening 126. FIG. 1d shows the lid in the “open” configuration, allowing more rope to be positioned into the front compartment 104.

The divider wall 108 may adapt its shape based on the size and volume of the contents positioned in the selected separate compartments 104, 106. This allows items to fit into the main compartment 128 efficiently and fill up the available volume of the main compartment, even while being segregated into the separate internal compartments 104, 106. Because the divider wall 108 may be flexible, it may allow the vertical stacking of items in one compartment relative to the items positioned in the other separated compartment. The flexibility of the divider wall 108 may allow items in each of the separate compartments 104, 106 to be positioned in a variety of ways, including for example one item above the other (e.g. FIG. 1b), one item laterally next to the other, or even an item in a first compartment above an item in the second compartment, which is in turn above a different item in the first compartment (e.g. FIG. 1d). The volume of the first 104 and second 106 compartments in the example as shown in FIGS. 1a-1d, may be complimentary with one another, such that when combined together, they form the entire volume of the interior chamber 102 (which includes the main compartment 128) of the main body 112. This is irrespective of whether items are positioned in either or both of the compartments.

As described in more detail below, the portion of the rope 110 extending from the first (e.g. front) compartment 104 may be pulled to extract the rope 110 from the front compartment, such as when setting up a rappelling stage, without having to remove the items in the second (e.g. back) compartment 106, in part because the divider wall 108 keeps the items in each compartment separate from one another despite being stacked on top of each other in the volume of the main compartment 128.

In the example provided above, the contents of the front 104 and rear 106 compartments in the main body 112 may be switched. For instance, the length of rope 110 may be stored in the back compartment 106, with the gear stored in the front compartment 104. This may be advantageous where the length of rope 110 is heavier than the gear, so that the heavier content in the main compartment 128 is positioned closer to the back of the person carrying the backpack. Additionally or alternatively, the vertical placement of the gear and rope may be reversed, so the bottom and top vertical portions of the main compartment 128 may contain the gear, and the middle vertical portion of the main compartment 128 may contain the length of rope 110. In this case, the rope 110 may still extend out of the respective top opening of the compartment in which it's positioned, and out of the primary opening 126 of the main body 112, to extract the rope 110 from the main body 112 for the purposes described elsewhere herein.

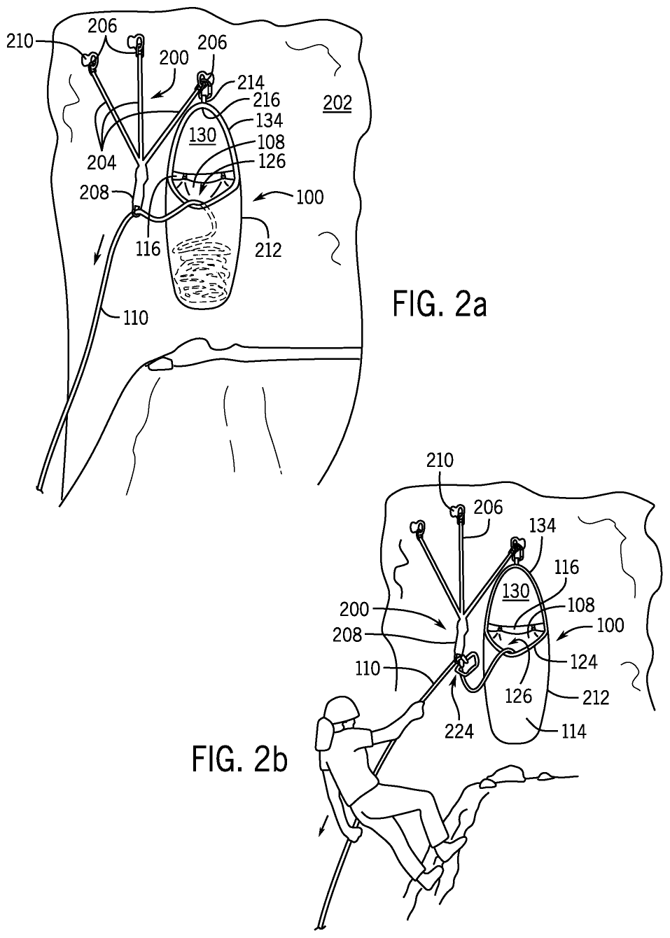

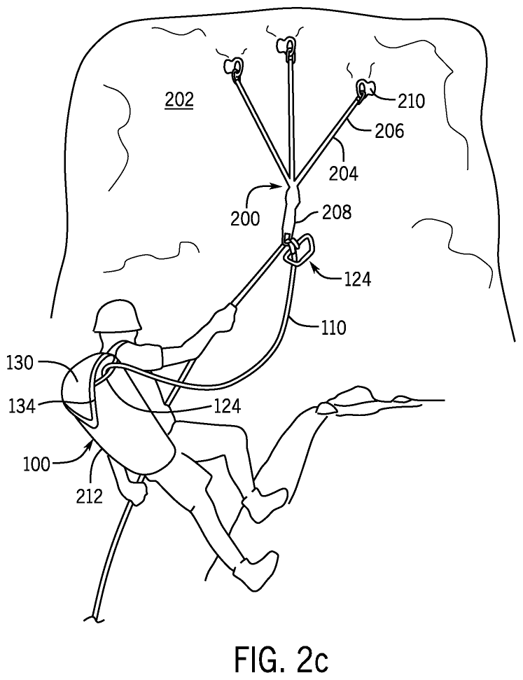

FIGS. 2a, 2b, and 2c represent examples of the use of the rope hauling container while canyoneering, and particularly during rappelling down a sidewall of a canyon or climbing up the sidewall of a canyon. FIG. 2a shows the rope hauling container 100, in this example in the form of a backpack 212, set up for a rappel descent stage. A climbing anchor 200 is attached to a rock or other structure 202 above the entry point of the rappel. The climbing anchor 200 in this case has three support legs 204, each appropriately attached at an end portion 206 to the rock surface by bolts, screws, or other appropriate equipment 210. The climbing anchor has a master point 208, which is a loop structure through which climbing rope 110 passes, or a rap ring is attached, and is the point at which the anchor 200 is loaded when in use.

In setting up for the rappel stage, the rope hauling container 100 may be selectively coupled to the wall structure 202 adjacent the anchor 200. In this example, the container 100 is coupled to and suspended from one of the bolts 208 securing the support legs 204 of the anchor 200. The lid 130 of the rope hauling container 100 is in the open position, with a securement loop 214 at the apex 216 of the open lid being coupled to the bolt 210. The opening 126 to the main compartment 128 is uncovered, and the divider wall 108 is coupled to the back wall 116 of the backpack, so the opening to the rope compartment 104 is open to a larger degree than the opening to the gear compartment. The rope 110 is stacked within the rope compartment 104, with a free end of the rope 110 extending out of the opening of the rope compartment 104. The free end of the rope 110 is passed or fed through the master point 208 of the anchor 200, and the appropriate length of the rope 110 required for the rappel stage payed out from the stacked rope in the rope compartment 104 through the master point 208. For example, a sufficient length of rope 110 may be a length where the free end of the rope is suspended two to three feet above the terminal point of the rappel stage.

The rope 110 is then restricted from further passage through the anchor point 208 by forming a block structure 224. The rappelling load will be applied by the rope 110 and block structure 224 to the master point 208, for example by using a clove-hitched carabiner or a figure-eight descender locked off in block mode, or another suitable block structure 224. Any equipment used in forming the block structure 224, such as the carabiner or figure-eight descender, may be stored in the gear compartment 106 of the backpack and easily accessed. At this point the rappel stage is prepared and ready for the rappel. The rope hauling container 100 provides a significant benefit in the preparation of the rappel stage because it is suspended off the ground near the top of the rappel stage in a convenient location, with the rope 110 and related gear and equipment separated and in their own internal compartments and easily accessible for use. The suspended hauling container 100 also keeps the rope free of unnecessary contact with surrounding rocks, sand, water, and other potential sources of wear and abrasion.

FIG. 2b shows rappeller descending the rope for the rappel stage without the backpack 212. In this example, the backpack remains coupled to the support wall at the top of the rappel stage. This may occur where the rappeller rappels down the stage prior to the last rappeller to rappel down the stage, which is shown in FIG. 2c. In this scenario, the rope hauling compartment keeps the rope stored in the rope compartment out of the dirt and sand, and separated from the gear in the gear compartment. It is prepared for use by the final rappeller to rappel down the stage with the intent of retrieving the rope 110 for subsequent use.

FIG. 2c shows the last rappeller to use the rappel stage, supported by the length of descending rope played through the master point of the anchor, with the block structure securing the rope from slipping through the master point. In this example the rappeller has removed the backpack from the wall structure, closed the lid over the opening, and shouldered the backpack to take it down the rappel stage. As the rappeller descends down the rappel stage, the rope extending from the block structure into the rope compartment of the backpack plays out from the rope compartment 104. The rope 110 is extracted from the rope compartment 104 by passing through the rope compartment opening, and past top rim 124 of the main opening 126 and the peripheral edge 134 of the lid 130. As described below with respect to FIG. 4a, the peripheral edge of the lid 130 and the rim 124 of the main opening 126 include a seam binding structure 140 which provides a smooth surface against which the rope slides past for a predictable and uninterrupted extraction of the rope 110. Because the rope 110 is stacked in the rope compartment 104 and separated from the items in the gear compartment 106 by the divider wall 108 (see FIGS. 1b, c, and d), the rope 110 extracts smoothly and without tangling with the gear. This is in contrast to existing rope hauling structures which either do not include separate gear space inside the main compartment to keep from tangling the rope, or require the rope to be carried separately outside of a backpack the rappeller was wearing to carry her gear.

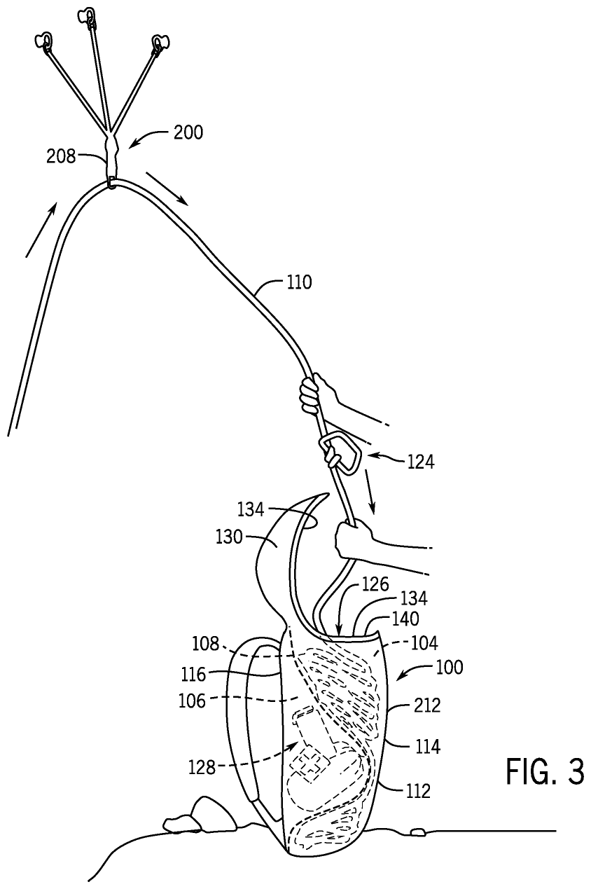

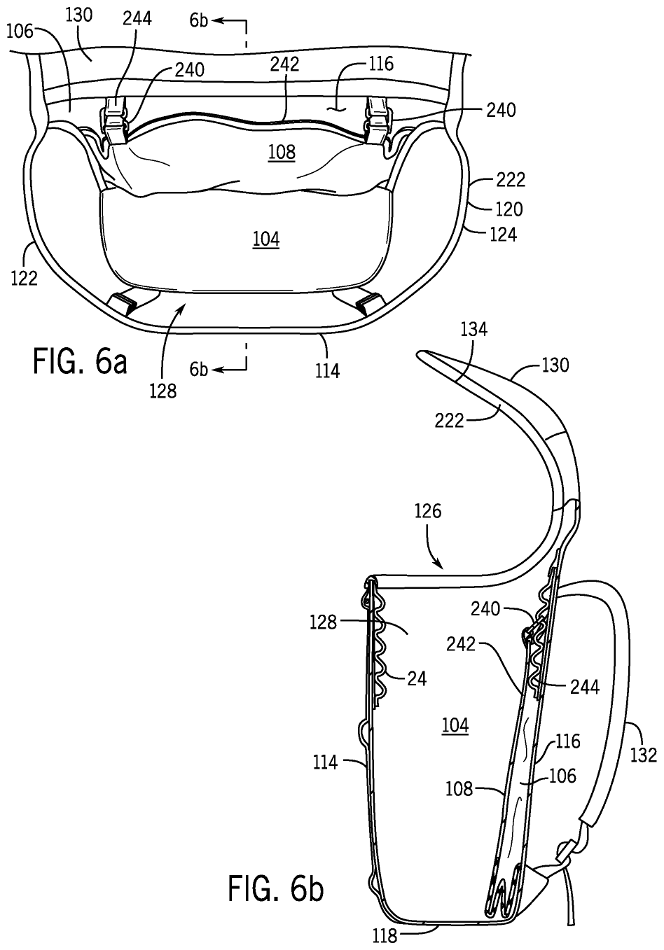

Referring to FIG. 3, after the rappel stage is finished, the rappeller may retrieve the rope 110 and stack or flake it into the rope compartment 104, ready for its next use. The rope hauling container 100 provides unique benefits at this point of the rappelling stage also. For example, the main body of the rope hauling compartment may be self-supporting to stand upright on a support surface with the lid 130 open to allow the rope to be top-loaded easily into the rope compartment 104, or may be leaned against an object, such as a rock, or suspended by its lid 130. In this way the contact between the rope and the ground is reduced, which reduces wear and damage to the rope. If necessary the container may be laid on its side on the ground. Also, the top edge 242 (see FIG. 6a) of divider wall 108 may be coupled to the back wall 116 of the backpack in order to enlarge the opening the rope compartment 104 to allow the rope to be conveniently reloaded into the rope compartment 104, separate from the gear in the gear compartment 106. In one example, the rope 110 is stacked into the rope compartment by pulling the length of rope that had played out during the descent of the rappel stage through the master point 208. The block structure 224 does not inhibit the rope in this direction, and the descending length of the rope 110 can be retrieved and stored in the rope compartment 104.

FIG. 4a through FIG. 9a show more detail of the rope hauling container 100 in the example form of a backpack 212 described with respect to FIGS. 2a-2c and FIG. 3. FIG. 4a shows the main body 112 with the front side 114, rear side 116, and two opposing sides 120, 122 as noted above. The main internal compartment 128 is formed in the main body 112, with an opening 126 defined by the upper edge 124 of the front wall 114 and opposing side walls 120, 122. The shoulder straps 132 are secured, in this example, to the rear side 116 of the main body 112. The main body 112 may include a number of attachment points 300 on its exterior surface for securing various gear, and may also include drain holes in a lower portion to allow water and other things easily flow out of the main compartment 128.

As seen in FIGS. 4a, 4b, and 4c, the lid 130 extends from the back wall 116 and is movable between a closed position shown in FIG. 4a and an open position shown in FIG. 4b. The lid 130 has a main body defining a shape that is widest where it extends from the back wall 116, tapering to a rounded apex 216 at its free end. Pockets may be formed on the outer and/or inner surfaces of the lid. As best seen in FIG. 4b, the width dimension W of the lid, from one opposing side wall to the other opposing side wall is sufficient to generally extend across and cover over the opening 126 (formed by the upper rim 124) into interior compartment of the backpack. The length L of the main body of the lid 130 from the back wall 116 to the front wall 114 is sufficient to generally extend across and over the opening 126 into the interior compartment 128. The dimension of the opening 126 of the main body 112 is controlled by a drawstring system 142. The drawstring system includes a series of apertures formed around the rim 124 of the main body 112 of the backpack, and a draw string threaded through the apertures. To reduce the size of the opening 126 into the main body 112, and allow the lid 130 to completely cover the opening, the draw string is shortened, which gathers the top rim 124 of the main body to reduce the size of the opening. The maximum size of the opening 126 into the main body 112, where the lid 130 generally covers the opening 126, is obtained when the draw string system 220 is loose and does not cause gathering of the top rim 124 (such as is shown in FIG. 4a).

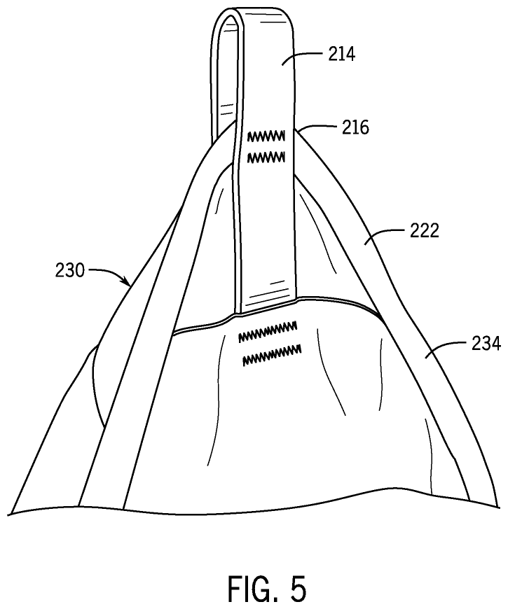

Continuing with FIGS. 4b and 4c, the peripheral edge 134 of the main body of the lid 130 includes a seam binding 222 made of a webbing material 224. The seam binding 222 may extend continuously from the peripheral edge 134 of the lid 130 onto and around the upper rim 124 that forms the opening 126 of the main body 112. The transition region between the lid main body 130 and the opposing sidewalls 120, 122, such as where the lid 130 bends or pivots to cover the main opening 126, may also include the seam binding structure. As shown in FIG. 4c, the continuous seam binding 222 may be constructed of a single length of webbing 224 folded over the peripheral edge 134 and rim 124 and sewn through to secure it to the peripheral edge. The continuous seam binding 222 may also include more than one length of webbing 224 secured together. In some examples, such as in FIGS. 4b, 4c and 5, a securement loop 214 is secured to the seam binding, and optionally the main body of the lid 130, at the apex 216 of the lid 130. The securement loop 214 is made of a strong material, such as the same webbing forming the seam binding 222, so that it is an extension of the continuous seam binding structure 222. The securement loop 214 serves as the attachment point for suspending the rope hauling container 100 by its lid 130, and for securing the lid 130 in a closed position (such as by use of a carabiner with the attachment point 300 on the front wall 114). Alternatively, the lid 130 may be secured to the rim 124 defining the opening 126 by a continuous closure, such as a zipper. In this instance, the continuous closure mechanism may be secured to the lid 30 and rim 124 in addition to the seam binding, and for example may be on top of the seam binding.

Continuing with FIG. 4a, the continuous seam binding 222 is very strong, and together with the loop 214, may support a fully loaded rope hauling container 100 filled with rope and gear, as shown in FIGS. 2a and 3. The force created by the fully loaded rope hauling container 100 being suspended by its securement loop 214 is supported almost entirely by the continuous seam binding 222. Because it is continuous, the seam binding 222 does not entirely rely on the structural strength of the main body 112 or lid 130. The seam binding 222 also may create a smooth guide surface across which the rope 110 glides while being extracted from the rope compartment 104. This smooth guide surface is beneficial by reducing the occurrences of tangles, knows, kinks, and other problems that may arise when rope is extracted from a rope compartment 104. The rope 110 may engage the seam binding 222 of the lid 130, the seam binding of the rim 124 around the opening 126 of the main body 112, or both, and remains in contact with the seam binding 222 in any direction of extraction (where the seam binding is continuous) from the rope compartment 104, further assisting in a controlled and safe extraction of the rope from the rope 110 compartment 104.

The main compartment 128 and the different configurations of the internal compartments 104, 106 of an example of the main body 112 of the backpack is shown in FIGS. 6a and 6b, 7a and 7b, and 8a and 8b. The front wall 114, back wall 116, opposing side walls 120, 122, and bottom wall 118 together define the interior chamber 102, which includes the main compartment 128. As shown, the walls are defined by a single-layer exterior structure of the main body 112. The exterior structure of the main body 112 may in other examples include more than one layer, and may also include additional pockets, sections or chambers inside the interior chamber 102, in addition to the main compartment 128 and/or on the exterior of the main body 112. Also, the main compartment 128 the main body 112 in these other examples may not be formed by the exterior walls of the main body 112, but may instead be formed by other walls positioned inside the exterior walls, or maybe formed by a combination of exterior and interior walls of the main body 112. For clarity, the example described herein has main body 112 of a single layer exterior wall that defines the interior chamber 102. The interior chamber 102, in this example, is made up entirely of the main compartment 128, which is divided into the first 104 and second 106 compartments by the divider wall 108. In some embodiments, the main compartment 128 is divided into a wedge shaped compartment (e.g., narrower at the top of the compartment than at the bottom) and funnel shaped compartment (e.g., wider at the top of the compartment than at the bottom). For example, the first compartment 104 may be funnel shaped and the second compartment 106 may be wedge shaped. As noted above, the interior chamber 102 may include other structures separate from and additional to the main compartment 128. Reference herein to description of structure forming the main compartment 128, such as a front wall, back wall, side walls, or bottom wall, do not only mean the exterior walls of the main body, but instead may also include walls interior to the main body 112 but that define the bounds of the main compartment 128 in which the first compartment 104 and second compartment 106 are formed at least in part by the divider wall 108. Also, unless otherwise specified, the divider panel may be secured to a wall or portion that is inside the referenced exterior wall of the main body 112, such as one that forms a wall that defines at least a portion of the main compartment 128.

FIGS. 6a and 6b show the backpack 212 configured with the divider wall 108 secured at least in part against the back wall 116 of the main compartment 128 of the backpack, leaving the rope compartment 104 forming the majority of the main compartment 128 of the main body 112. In this example, two fasteners 240 are positioned at the top edge 242 of the divider wall 108 and are removably coupled to corresponding rear loop receivers 244 attached to the back wall 116 of the main compartment 128. More or fewer fasteners and loop receivers may be used. The fasteners 240 engage the rear loop receivers 244 and hold the top edge 242 of the divider wall 108 in place. Where the gear compartment 106 is empty, or has few items placed in it, the divider wall 108 may remain against the back wall 116 of the main compartment 128 as shown. In this configuration the rope compartment 104 has a volume about equal to the volume of the full main compartment 128.

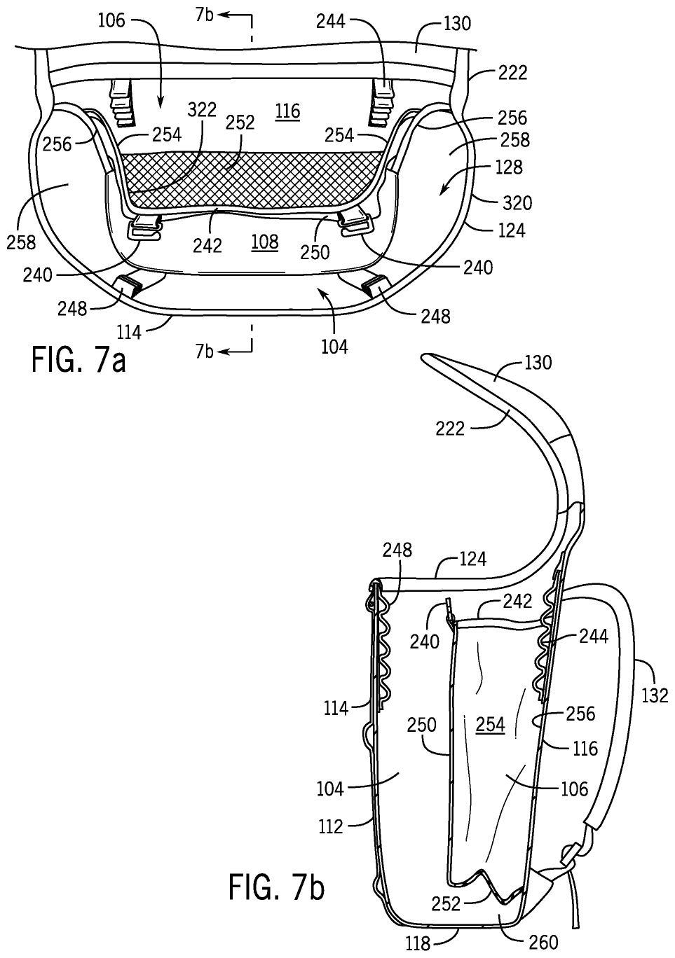

FIGS. 7a and 7b show the divider wall 108 extended halfway between the front 114 and back 116 walls of the main compartment 128 of the main body 112. In this configuration, the fasteners 240 located along the top edge 242 of the divider wall 108 are not coupled to any part of the walls of the main compartment 128 of the main body 112, and the divider wall 108 may stay in this intermediate position, or may collapse back to the back 116 wall of the main compartment 128, or extend further to the front wall 114 of the main compartment 128.

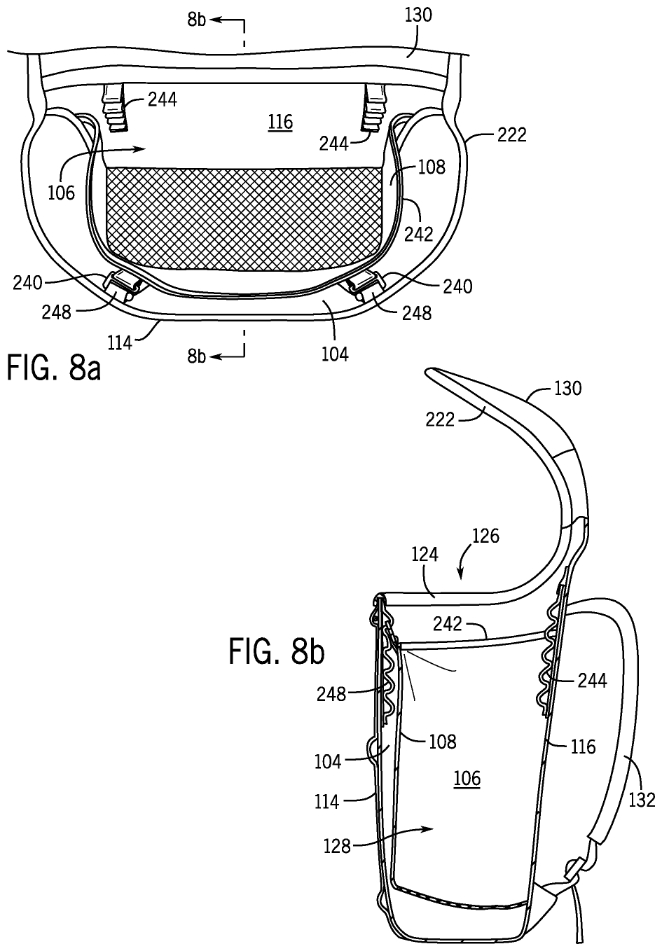

The divider wall 108 is secured to the front wall 114 of the main compartment 128 in FIGS. 8a and 8b, which show the divider wall 108 in its expanded configuration with the fasteners 240 at the top rim 242 of the divider wall secured to loop receivers 248 positioned on the front wall 114 of the main compartment 128 of the main body 112. In this example, the volume of the rope compartment 104 is smaller, and the volume of the gear compartment 106 is larger, than in the configurations shown in FIGS. 6a, b, and 7a, b.

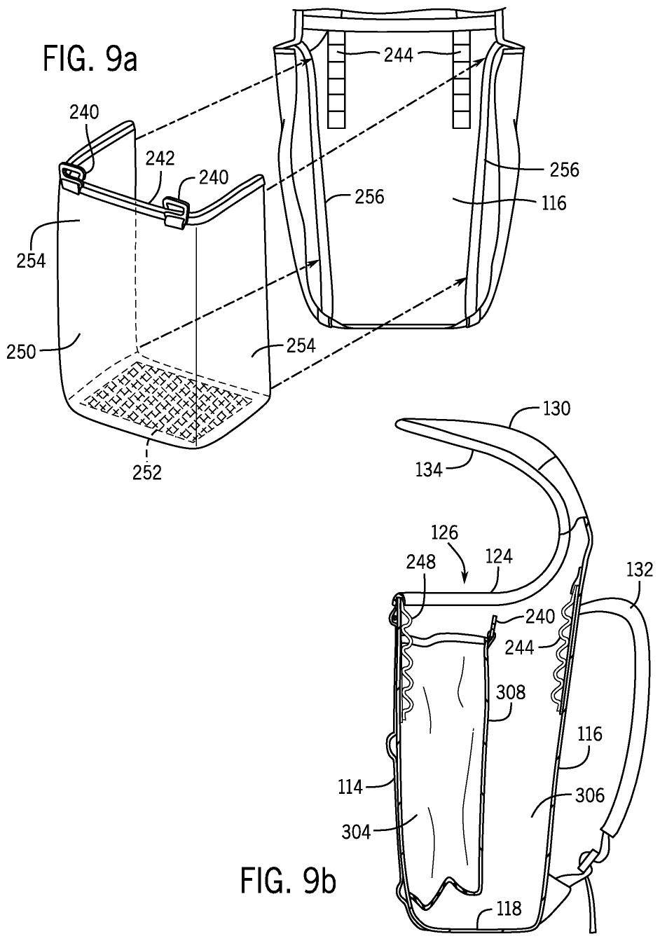

The structure of the divider wall 108 is described with respect to FIGS. 7a, 7b and FIG. 9a. FIG. 9 is a partial view of the main body 112 of the backpack, specifically the main compartment 128 of the backpack 212, with the opposing side walls 120, 122, front wall 114 and bottom wall 118 removed for clarity. The divider wall 108 may, in this example, have three sides, with a front portion 250, a bottom portion 250, and two opposing side portions 254. In general, this example of the divider wall 108 is shaped like a length of a U-channel, formed by the opposing side portions 254 and the front portion 250, with one closed end formed by the bottom portion 252. Free-edges of the bottom 252 and opposing side 254 portions are secured to the back wall 116 of the main body 112. The opposing side portions 254 are respectively secured to the back wall 116, each at a corresponding laterally-spaced seam 256 where the back wall 116 is attached to the opposing side walls 120, 122 of the main body 112. There may be gaps 258 formed between each side portion 254 of the divider wall 108 and the respective side walls 120, 122 of the main body 112. The bottom portion 252 may be secured to the back wall 116 at a location spaced above the bottom wall 118 of the main body 112 to form a gap 260 between the bottom portion 252 of the divider wall 108 and the bottom wall 118 of the main compartment 128 of the main body 112, forming an L-shaped volume (as seen in FIGS. 7b and 8b). In this example, the bottom portion 252 of the divider wall 108 may include apertures, such as with a mesh material, to allow water, sand, and other small items to pass through to the bottom of the main interior compartment. The bottom portion 252, side portions 254 and front portion 250 of the divider wall 108 may be made of solid materials with or without apertures, or may be discrete woven straps, or a plastic flexible sheet, or other type of material, or a combination, to form the separate compartments 104, 106 within the main compartment 128.

Continuing with FIGS. 7a, 7b, and 9a, the divider wall 108 separates the main compartment 128 of the main body 112 into the rope compartment 104 and the gear compartment 106, as described above. In this example, the volume of the main compartment 128 outside of the divider wall 108 is the rope compartment 104, and forms a volume bounded by the outside of the divider wall 108 and the front wall 114, opposing side walls 120, 122 and bottom wall 118. The gear compartment 106 in this example is the space inside the divider wall 108, and forms a volume bounded by the inside of the divider wall 108 and the back wall 116 of the main body 112. Since the divider wall 108 is made of a flexible material, and the main body 112 is made of a generally flexible material, the shape of the volumes may change based on the contents of the rope compartment 104, the gear compartment 106, or both of the compartments.

In another example, shown in FIG. 9b, the main body 112 is the same as described above with respect to FIGS. 4a-9a, with the divider wall 308 being oriented differently. Similar structure to that above is referred to with similar reference numbers. The divider wall 308 is attached to and extends from the front wall 114 of the main compartment 128. The compartment 304 is formed inside the divider wall 308 and is defined by the volume between the divider wall 308 and the front wall 114. The compartment 306 is defined between the divider wall 308 and the back wall 116 of the main compartment 128, and is defined by the volume between the divider wall 308 and the back wall 116, and opposing side walls 120, 122, and bottom wall 118, which may form the L-shape as described above with respect to FIGS. 7b and 8b. In this configuration, the rope may be stacked in compartment 306 closer to the canyoneer's back to make the load easier to carry, assuming the rope is the heaviest portion of the load.

The divider wall may attach to the walls of the main compartment in different locations as desired to form the separate rope and gear chambers. For instance, the divider wall may be a sheet of flexible material that extends width-wise across the main compartment of the main body, and attaches at each of the opposing side walls to define two compartments separated by the divider wall. The divider wall may be attached to the bottom wall of the main compartment, or may define its own bottom wall as described above.

The openings of each of the separate compartments within the main compartment 128 of the main body 112 are described here with reference to FIGS. 7a and 7b. The opening 320 of front compartment 104, which is adjacent to at least the front wall 114 of the main body 112, is defined at least in part by the combination of the portion of the rim 124 formed along the top edge of the opposing side walls 120 and the top edge of the front wall 114 and the top edge 242 of the divider wall 108. The opening 322 of rear or back compartment 106, which is adjacent to the back wall 116 of the main body 112, is defined at least in part by the combination of the top edge 242 of the divider wall 108 and the top portion of the back wall 116 at where the lid 130 extends.

In the examples described so far with respect to FIGS. 1a through 9a, the size of the opening 320 into the front compartment 104, or the opening 322 into the rear compartment 106 allow for top-loading through the main opening 126 into each respective compartment. The size of each of the opening 320 or 322 may vary based on the location of the top edge 242 of the divider wall 108. In the example described in FIGS. 1a through 9b, the free edges of the divider wall 108 as shown in FIG. 9a may be respectively secured to portions of the walls forming the main compartment 128, and in particular along a seam between the back wall 116 of the main body 112 and the opposing side walls 120, 122 of the main body 112. The divider wall 108 may be attached at different locations within the main body 112. As noted, the ends of the top edge 242 of the divider wall 122 may be removably coupled to the front wall 114, or to the back wall 116, or may be left uncoupled. The bottom portion 252 of the divider wall 108 may be attached to the bottom wall 118 and may not allow for a gap between the divider wall 108 and the bottom wall 118.

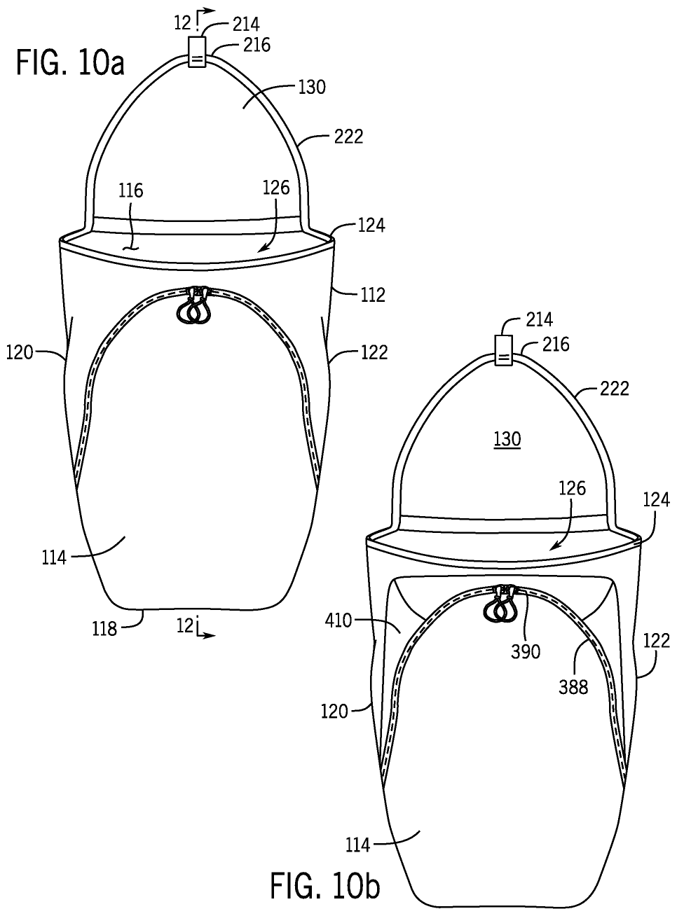

FIGS. 10a, 10b, 11, and 12 show other examples of the rope hauling container having a rope compartment and a gear compartment separated by a divider wall. The structure of this example is similar to the earlier example shown in FIGS. 4a-9a, with the differences noted below. While in the earlier example the rope and gear compartments were both accessible and top-loaded through the opening positioned generally at the top portion of the main body, in these examples one compartment is accessible and top loaded through an opening formed in the top portion of the main body while the second compartment is accessible and loaded through a secondary opening, which may be opened and closed using a selectively openable fastener positioned at least partially on a sidewall of the main body. The divider wall separates the two compartments and keeps the contents of each from mixing with or tangling the contents of the other compartment.

Referring to FIG. 10a, in this example the rope hauling container 100 is in the form of a backpack similar to that described with respect to FIG. 4a through FIG. 9a, with the similar or the same structure using the same references as above. The main body 112 includes a front wall 114, a back wall 116, opposing side walls 120, 122, and a bottom wall 118 defining an internal chamber 378. Shoulder straps 132 may be attached to the back wall 116 for mounting on a canyoneer's back for carrying. The main body 112 defines an opening 126 formed by a rim 124 defined by the top edges of the front wall 114 and opposing sidewalls 120, 122, and portion of the back wall 116. The opening 126 allows access to a main compartment 380, as described below. A cinch closing structure 220 similar to that of the example above may be utilized to selectively reduce the size of the opening 126 if desired. A lid 130 extends from the back wall 116 and bends or folds about a top portion of the back wall 116 to move between a closed position where it covers the opening 126, and an open position where it uncovers the opening 126. When in the closed position, the lid 130 may be secured to the main body 112 by the securement loop 214 at the apex 216 of the lid 130. As noted with the above examples, the seam binding 222 extends continuously around the periphery of the lid 130 and the rim 124 forming the opening 126 in the main body 112 to serve as a guide for the rope 110 as it is extracted from the main compartment 380.

The opening 126 allows access to a main compartment 380 or cavity formed in the main body 112. In this example, the main compartment 380 of the main body 112 accessed through the opening 126 may be a unitary volume defining one compartments 384, for instance the rope compartment. The separate second compartment 386 is accessible through a secondary opening, such as a slit opening 388, that may be formed on one of the side walls of the main body 112. In this example, the slit opening 388 may be at least partially formed in the front wall 114 of the main body 112. The slit opening 388 may be selectively closeable by a closure mechanism 390 such as for example a zipper. The second compartment 386 is formed inside the main body 112 and adjacent to the first compartment 384, and separated from the first compartment by the divider wall 392. In this configuration, the compartment 384 may be most likely used to receive the rope 110, and compartment 386 may be most likely used to receive the gear. The compartment 384 and compartment 386 combine to form at least a portion of the internal chamber 378. The main compartment 380 in this example may be contiguous with the compartment 384.

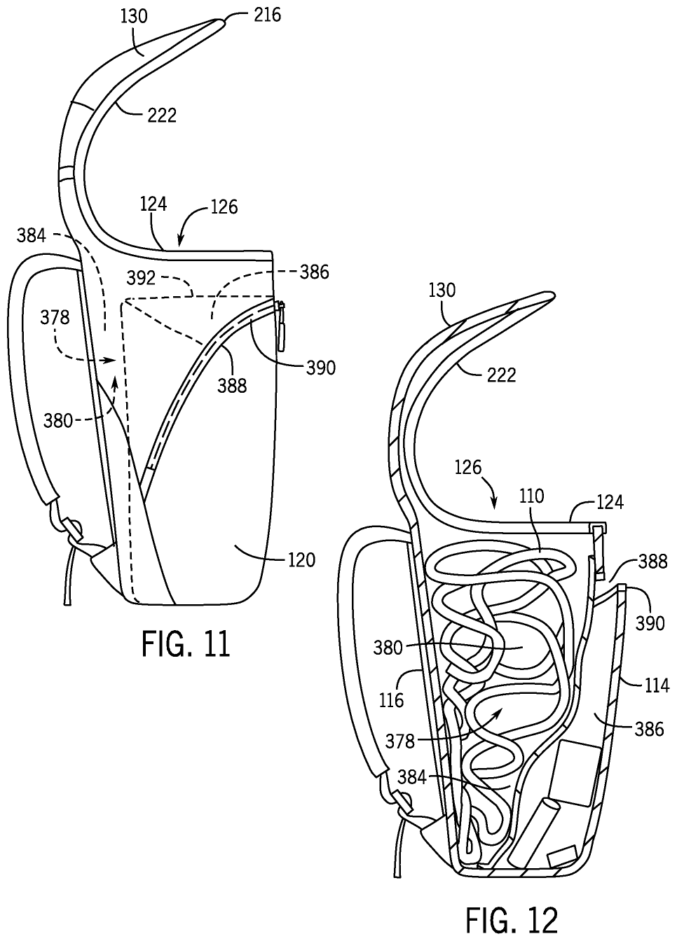

Referring to FIGS. 10a and 11, the slit opening 388 may extend at least partially across the front wall 114, and may extend at least partially across the opposing side walls 120, 122. In this configuration, the slit opening 388, when in the open configuration, may be large enough to easily receive the gear for placement in the second compartment 386. In the example show in FIGS. 10 and 11, the slit opening 388 has a curved, concave-downwardly shape, with the portions of the slit opening 388 on the opposing sidewalls 120, 122 angling upwardly to meet at an apex in the central upper portion of the front wall 114.

Referring to FIGS. 10a and 11, the slit opening 388, in this example, extends at one end from a point on one opposing sidewall 120 at an upward angle toward the top portion of the front wall 114, reaches an apex at the top central portion of the front sidewall 114, and then turns downwardly toward a terminal point on the other opposing sidewall 122 (not shown). This example of the slit opening 388 may be characterized as a concave-downwardly facing curve, and may be symmetrical about a longitudinal centerline of the front wall 144. In one example, a mechanical closure mechanism 390 allows selective opening and closing of the slit opening 388 to open and close the second compartment 386. In this example, the end of the slit opening 388 on one opposing sidewall, such as that shown in FIG. 11, is located at about one third of the distance between the bottom wall 118 and the top rim 124 of the main body 112, and about one-fifth of the distance from the back wall 116 to the front wall 114 in the configuration shown. The other end of the slit opening 388 is located on the opposing sidewall 122 at a similar or same respective location.

Continuing with reference to FIGS. 11 and 12, the divider wall 392 in this example is attached to the walls forming the main compartment 380 of the main body 112 to form a first compartment 384 that is top-loaded and compartment 386 that is loaded through the slit opening 388. In the example shown, the divider wall 292 is attached, at least in part, to the walls forming the main compartment 380 along a line of attachment that may track closely with the slit opening, but is spaced away from and towards the top rim 124 of the main body 112. The divider wall 292 is attached to the opposing sidewalls 120, 122 from near the ends of the slit opening 388 and in a direction towards the bottom wall 118, and is attached along the bottom wall 118 from one opposing sidewall to the other opposing sidewall. The volume of the first and second compartments 384, 386 in the example as shown in FIG. 12, may be complimentary with one another, such that when combined together, they form the entire volume of the internal chamber 378 of the main body 112. This is irrespective of whether either compartment contains articles or not.

In the side view of FIG. 12, the first compartment 384 that is top-loaded has the general shape of a funnel when the second compartment 386 holds gear. The first compartment 384 is positioned between the second compartment 386 and the back wall 116 of the main body 112. The top portion of the first compartment 384 is wide, in some instances as wide as the opening 126 in the main body 112. The first compartment 384 narrows down as the middle portion of the compartment extends down into the main body 112. The lower portion of the first compartment 384 extends downwardly from the middle portion, and is relatively narrow. The first compartment 384, from the top portion to the bottom portion, extends from one opposing side wall 120 to the other opposing sidewall 122. The first compartment 384 may be used as the rope compartment, with the rope stacked into the first compartment 384 by top-loading through the opening 126. The load created by the rope in the first compartment 384 is located near or adjacent to a canyoneer's back, which provides more stable hauling of the load.

Continuing with FIG. 12, the second compartment 386 may extend from one opposing side wall 120 to the other opposing side wall 122, and has a volume that generally increases from its top portion to its bottom portion. This may be in a complimentary fashion to the shape and volume of the first compartment 384. The second compartment 386 may be used for gear storage, and based on the volume of the gear contained in the second compartment 386 may allow the divider wall 392 to move and expand the first compartment to allow for more room for rope storage. The flexible divider wall 392 allows adjustment of the size of the first 384 and second 386 compartments depending on the contents of each.

The attachment of the divider wall 392 to the interior of the main compartment may be continuous, or periodically discontinuous. The attachment may be permanent, such as by sewing, glue, adhesive, or mechanical fasteners. The attachment may be removable, such as by Velcro or other releasable fasteners. The divider wall 392 may be made of a woven or non-woven, natural or man-made fabric, and may be solid or have one or more apertures formed therein. The divider wall 392 may be attached in different locations to form a differently-shaped second compartment, and/or a differently-shaped first compartment.

FIG. 10b is an example of the rope hauling container that is similar to that shown in FIGS. 10a, 11, and 12, and similar structural features are referred to by the same reference numbers as above. The main body 112 of the example in FIG. 10b includes a front wall 114 with a gusset 410 formed outwardly from the front wall 114. The slit opening 388 is formed in the gusset 410. The gusset 410 provides extra volume inside the second pocket 386 as compared to the slit opening 388 formed directly in the front wall 114 of the example shown in FIGS. 10a, 11, and 12.

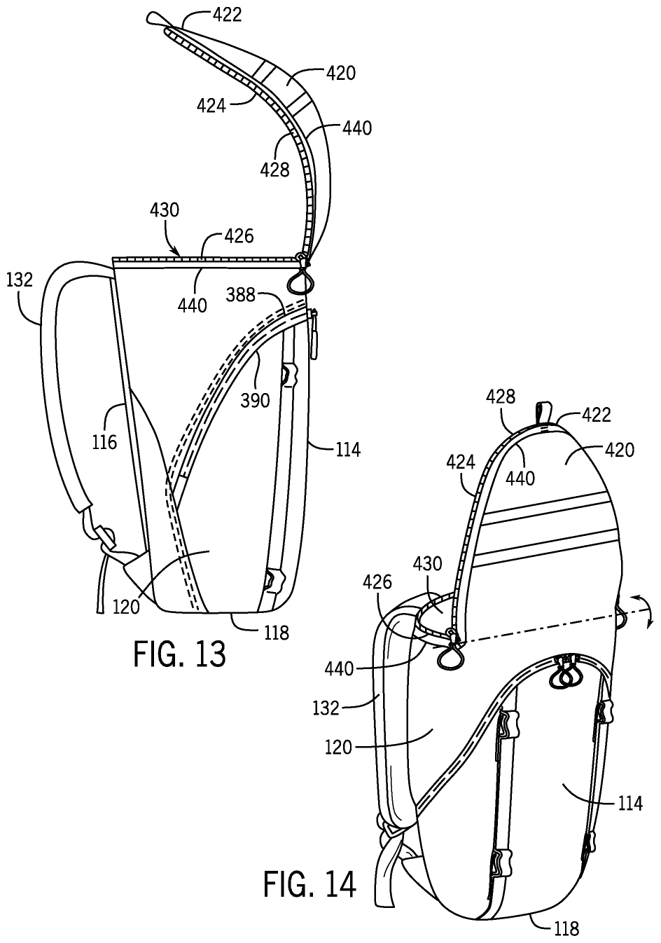

Another example of the rope hauling container 100 is shown in FIG. 13 and FIG. 14. In this example the rope hauling container is in the configuration of a backpack, as with examples described above with respect to FIGS. 10a, 11, and 12. In particular, this example is similar in structure to the example shown in FIGS. 10a, 11 and 12, namely that the main body, interior chamber, main compartment, top opening, slit opening, and divider wall structure are common between the two examples. In this example the lid 420 is an extension of the front wall 114 of the main body 112, and opens and closes by pivoting about a top portion of the front wall 114, with the apex 422 of the lid 420 being adjacent the top of the back wall 116 when closed, and moving up and away from the back wall when open. The periphery of the lid 424 is secured to the corresponding portions of the rim 426 defining the opening 430 in the main body by a mechanical closure mechanism 428, such as in one example a zipper. When this example is in use and hung from a structure during a rappelling event, the apex 422 of the lid is coupled to the structure, and the front wall 114 of the main body 112 lies against the structure, with the back wall 116 of the main body 112 positioned away from the structure. The seam binding 440 similar to that of the first two examples (FIGS. 4-9 and FIGS. 10-12) is attached around the periphery of the lid 420 and the rim 426 defining the opening 430 in the top of the main body 112, and supplies the strength to suspend the rope hauling container 100 from the securement loop on the apex 422 of the lid 420. In this example, the mechanical closure mechanism 428 is attached on top of the seam binding 440, and as the rope is extracted from the rope compartment, the rope passes over the guide surface formed by either the mechanical closure mechanism 428 on the top rim 426 around the opening 430, or on the periphery of the rim, or both.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A rope hauling and deployment container comprising:
a main body including an upper portion defining a rim portion forming at least a portion of a primary opening into an interior chamber of the main body;
a divider wall separating the interior chamber into at least two separate compartments inside the main body;
a lid extending from the rim portion, wherein;
the lid is movable between a first orientation allowing access to the primary opening and a second orientation at least partially covering the primary opening,
the lid has a peripheral edge forming a continuous extension of the rim portion that defines the portion of the primary opening,
the lid includes a loop structure at a central location on a free edge of the lid; and
an elongated seam binding attached to and covering at least a portion of the peripheral edge and the rim portion, the seam binding forming a load bearing structural loop and a guide surface along the at least a portion of the peripheral edge and the rim portion for smoothly engaging a length of rope deployed from the container.

2. The rope hauling and deployment container of claim 1, wherein the divider wall is attached in at least two different locations within the interior chamber, and is flexible to allow items in each of the separate compartments to be stacked vertically with respect to one another.

3. The rope hauling and deployment container of claim 1, wherein the main body includes shoulder straps attached to a back wall thereof.

4. The rope hauling and deployment container of claim 1, wherein:
the main body further comprises a back wall;
the divider wall includes two laterally-spaced edges;
each of the at least two laterally spaced edges is attached at respective spaced apart locations along the back wall;
the divider wall includes a bottom edge extending between the two laterally-spaced edges and attached to the back wall; and
the divider wall and the back wall define one of the at least two separate compartments.

5. The rope hauling and deployment container of claim 4, wherein a bottom portion of the divider wall includes at least one aperture formed therein.

6. The rope hauling and deployment container of claim 4, wherein the one of the at least two separate compartments has a volume smaller than the other of the at least two separate compartments.

7. The rope hauling and deployment container of claim 1, wherein the at least two separate compartments are accessible through the primary opening.

8. The rope hauling and deployment container of claim 1, wherein the main body further comprises a front wall and a back wall, and the divider wall has a top edge selectively movable from a position adjacent to the front wall to a position adjacent to the back wall.

9. The rope hauling and deployment container of claim 1, wherein:
the main body further comprises a front wall and a back wall;
the divider wall has a fastener positioned along a top edge thereof; and
the fastener is selectively coupleable to either the front wall to enlarge the primary opening to a first of the at least two separate compartments, or the back wall to enlarge the primary opening to a second of the at least two separate compartments.

10. The rope hauling and deployment container of claim 1, wherein a first of the at least two separate compartments is accessible through the primary opening, and a second of the at least two separate compartments is accessible through an exterior pocket formed in the main body.

11. The rope hauling and deployment container of claim 10, wherein the divider wall is at least partially attached at opposing side portions of the back wall, and at least partially attached a lower portion of the back wall.

12. The rope hauling and deployment container of claim 1, wherein a first compartment of the at least two separate compartments is funnel-shaped and a second compartment of the at least two separate compartments is wedge shaped.

13. The rope hauling and deployment container of claim 1, wherein the lid is secured to the main body by a linear closure mechanism.

14. The rope hauling and deployment container of claim 1, wherein the main body comprises a front wall and the lid extends from the front wall.

15. The rope hauling and deployment container of claim 1, wherein the main body comprises a back wall and the lid extends from the back wall.

16. A rope hauling and deployment container comprising:
a main body including a front panel and a back panel that, together, at least partially define an interior chamber of the main body and a primary opening in communication with the interior chamber, a lid portion extending continuously from the front panel or the back panel, the lid portion and the rim portion together defining a peripheral edge, wherein the peripheral edge is covered at least in part by a seam binding; and
a divider wall separating the interior chamber into at least two compartments inside the main body.

17. A rope hauling and deployment container as defined in claim 17, wherein the divider wall has a top edge selectively movable from a position adjacent to the front panel to a position adjacent to the back panel, and wherein the top edge is selectively securable in each position.

18. The rope hauling and deployment container of claim 16, further comprising a secondary opening formed in an exterior of the main body, wherein a first of the at least two compartments is accessible through the primary opening, and a second of the at least two compartments is accessible through the opening.

19. The rope hauling and deployment container of claim 16, wherein a first compartment of the at least two separate compartments is funnel-shaped and a second compartment of the at least two separate compartments is wedge shaped, the first and second compartments defining the volume of the interior chamber.

20. A rope hauling and deployment container comprising:
a main body that defines an interior chamber, wherein the interior chamber is accessible via a primary opening with a peripheral edge formed in an upper portion of the main body;
a divider wall separating the interior chamber into at least two compartments inside the main body; and
a seam binding attached to at least a portion of the peripheral edge, and forming a load bearing structural loop, and wherein the seam binding forms a guide surface along at least a portion of the peripheral edge configured to smoothly engage a length of rope deployed from the container.
